(19) United States
(12) Patent Application Publication
(10) Pub. No.: US 2011/0259530 A1
(43) Pub. Date: Oct. 27, 2011

(54) ROLLER COVER

(75) Inventors: Peter T. Brook, Darrington (GB); David Walker, Leeds (GB)

(73) Assignee: DEROLO LIMITED, LEEDS, YORKSHIRE (GB)

(21) Appl. No.: 13/125,489

(22) PCT Filed: Oct. 19, 2009
(86) PCT No.: PCT/GB2009/051400

§ 371 Date: Jul. 11, 2011

(30) Foreign Application Priority Data
Oct. 22, 2008 (GB) 0819360.9

(51) Int. Cl. E04H 4/10; G05G 1/54; F16H 21/10; G05G 1/04

(52) U.S. Cl. 160/120; 160/271; 160/267.1; 160/309; 160/405; 74/519; 74/89.2

(57) ABSTRACT

A roller cover and mechanism of operation of a roller cover is described. The roller cover comprises a body portion and at least one track along which the body portion is adapted to move. The mechanism of operation of the roller cover comprises a winding system, and winder and a drive system for raising and lowering the track. The winding system comprises a first spindle and a second spindle and a supporting sheet. The winder comprises an arm secured substantially perpendicularly to the longitudinal axis of the first spindle. The drive system comprises an articulated arm rotatably attached at one end thereof to the track.

The present invention relates to a cover for a hot tub, swim spa or the like. In particular, the invention relates to a roller cover for a hot tub, swim spa or the like.

Hot tubs and swim spas are popular leisure installations, very often situated on patios, decks or in gardens. In view of the fact that they are often installed outdoors, hot tubs and swim spas must be protected from the elements and must be insulated to prevent the heat being lost from the water. The hot tubs and swim spas must also be protected from access by children. Such protection, and a degree of insulation, is often provided by a cover.

Hot tubs and swim spas are generally covered by large blocks of plastic-, usually vinyl-coated polystyrene or foam. The blocks cover the upper surface of the tub or spa, and are effective in protecting the water in the hot tub or swim spa from the elements. However, the covers are heavy and cumbersome to remove and store in order to use the tub or spa, since they must be lifted off the top of the tub or spa. The covers are also difficult to lift back onto the tub or spa after use, especially when the user is wet and getting cold. The difficulty associated with the removal and replacement of the cover can mean that the hot tub or swim spa is not used regularly, or is only used when two people are present to share the weight of the cover.

A variety of mechanical devices are available to assist in the removal of hot tub covers. All of the devices focus on covers which are solid in construction (as described above) or have a substantially central fold line to allow the cover to be folded in half before removal. The devices work on the principle of aiding a pivoting movement of the cover about an edge of the hot tub or swim spa. Such devices begin to fail when the cover itself becomes saturated with water and, therefore, even heavier. Replacement of both cover and mechanism is the usual result of such failure, and frequent replacement of one or both of the cover and the mechanical device can be commonly experienced throughout the life of the hot tub or swim spa.

Even with a handling device, the covers are heavy, and also require substantial space to the side of the hot tub or swim spa to allow for their movement to the storage position.

It is an object of the present invention to address these and other problems associated with the prior art.

According to a first aspect of the present invention, there is provided a roller cover comprising a body portion, a track and a body portion retaining means, wherein the said track is external to the body portion retaining means and the body portion is moveable along the track.

Preferably, the roller cover is a cover for a hot tub, swim spa or the like.

Preferably, the body portion is moveable along the track in a substantially horizontal plane.

Preferably, the body portion comprises a plurality of louvres. The louvres may be metal, plastic, wood, or any other suitable material. Preferably, the louvres are plastic or metal.

Preferably, each of the louvres is hollow. Preferably, the hollow cavity of one or more of the louvres is filled with an insulating material. Preferably, the insulating material is a foam material.

The louvres may comprise reinforcing means. Preferably, the reinforcing means comprise metal rods or tubes, for example steel rods or tubes, or rods of any other suitable material. Preferably, the reinforcing means are located within the hollow area of one or more louvres.

Preferably, the body portion retaining means is a housing. Preferably, the body portion retaining means is adapted to retain substantially the whole of the body portion when the body portion is in a fully open position. Preferably, the body portion retaining means is mounted in a side of the hot tub, swim spa or the like.

Preferably, the body portion is stored around a spindle when the cover is open. Preferably, the spindle is located within the body portion retaining means. Preferably, the longitudinal axis of the spindle is substantially parallel to the louvres of the body portion. Preferably, the spindle is rotatably mounted on a side of the hot tub, swim spa or the like. Preferably, the spindle is rotatably mounted within the body portion retaining means. Preferably, the spindle is rotatably secured in a housing mounted on a side of the hot tub, swim spa or the like.

The body portion may be substantially flat or may be tapered from the centre towards the distal ends of the louvres, such that the body portion comprises a ridge along its centre line.

When the body portion is tapered from the centre towards the distal ends of the louvres, preferably, the spindle is correspondingly tapered to accommodate the louvres.

Preferably, the body portion of the roller cover is operable to form a seal along the upper edge of a hot tub, swim spa, or the like, when the cover is in a closed position.

Preferably, the body portion comprises a strip of waterproof material corresponding to the shape of the upper edge of a hot tub, swim spa or the like, to form a seal when closed. Preferably, the body portion comprises a sheet of waterproof material on a surface of the body portion. Preferably, the waterproof material is an insulating material. Preferably, the waterproof material is a rubber material or closed-cell polymer, or flexible high insulation composite materials.

Alternatively, the body portion may comprise a sheet of insulating material on a surface of the body portion.

Preferably, the track is mounted on a side of a hot tub, swim spa, or the like, below an upper edge thereof. Preferably, the track is substantially perpendicular to the louvres of the body portion.

Preferably, the track comprises a guide along which the body portion is movable. Preferably, the guide is a monorail, preferably a monorail having an inverted ‘V’ shape in cross section.

Preferably, the body portion comprises at least one guide member. Preferably, the or each guide member is mounted on the body portion at one end of a louvre. The or each guide member fits over the guide in the track, and is movable therealong. The movement of the or each guide member along the guide reduces the friction experienced by the body portion during motion, and therefore reduces the likelihood of the body portion snagging or getting stuck whilst moving along the track.

Preferably, the body portion comprises a plurality of guide members at the distal ends of the louvres.

Preferably, the guide members are formed from a low friction material, preferably a plastics material such as nylon.

Preferably, the or each guide member comprises an engagement portion operable to engage the guide in the track. The engagement portion may comprise a profiled section corresponding to the profile of the guide in the track.

Preferably, the track is operable to provide a clearance between the body portion of the roller cover and the upper edge of a hot tub, swim spa or the like when the cover is in an open or partially open position. Preferably, the track is operable to provide no clearance between the body portion of the roller cover and the upper edge of a hot tub, swim spa or the like when the cover is in a closed position.

Preferably, there is a clearance of between approximately 10 mm and approximately 100 mm between the body portion and the upper edge of a hot tub, swim spa or the like when the cover is in an open position. More preferably, there is a clearance of between approximately 20 mm and 70 mm. Most preferably, there is a clearance of approximately 40 mm.

Preferably, the track is movable between a position in which there is clearance between the body portion and the upper surface of the hot tub or swim spa and a position in which there is no clearance between the body portion and the upper surface of the hot tub or swim spa by means of at least one rotatable leg. Preferably, the or each leg is operable to rotate from a first position in which the or each leg is substantially perpendicular to the track to provide clearance, to a second position in which the or each leg is at a substantially acute angle to the track to provide no clearance.

Preferably, a plurality of rotatable legs is provided to move the track.

Preferably, the roller cover comprises an articulated arm to drive the movement of the rotatable legs. Preferably, the articulated arm is driven by a motor.

The roller cover may be movable along the track manually or by means of a motor. Preferably, the roller cover comprises a motor to facilitate movement of the body portion along the track. The roller cover may further comprise a crank arm to allow for manual movement of the body portion.

Preferably, the roller cover comprises a tubular winding system to allow smooth movement of the body portion.

Preferably, the roller cover comprises two tracks. Preferably, the tracks are located at the distal ends of the louvres of the body portion. Preferably, the two tracks are mounted on opposing sides of the hot tub, swim spa or the like.

The or each track may be retro-fitted on to a side of the hot tub, swim spa or the like, or may be integrally formed with the hot tub, swim spa or the like.

According to a second aspect of the invention, there is provided a winding system for a roller cover, the winding system comprising a first spindle adapted to receive a cover portion of the roller cover, and a second spindle adapted to receive a supporting sheet.

By the use of the term ‘roller cover’ in the present application, it is meant any cover adapted to roll about a spindle. The cover may be made from a single continuous piece of material, or from a number of sections of one or more different materials secured together. The material from which the cover is made may be rigid or flexible. The roller cover may form a solid cover, or may comprise one or more gaps. The gaps may form windows in the roller cover.

Preferably, the winding system is operable to wind and unwind a roller cover about the first spindle.

Preferably, the winding system is operable to wind and unwind the roller cover is any linear or non-linear plane. More preferably, the winding system is operable to wind and unwind the roller cover is any linear plane.

Preferably, the winding system is operable to wind and unwind the roller cover when the roller cover has any orientation. For example, the winding system may be operable to wind and unwind a substantially vertically oriented roller cover in a substantially horizontal plane, or a substantially horizontally oriented roller cover in a substantially horizontal plane, or a substantially horizontally oriented roller cover in a substantially vertical plane, and so on.

Preferably, the movement of the roller cover is not limited to just the substantially horizontal and substantially vertical planes, and may be in a plane at any angle to the horizontal or vertical plane. Likewise, the orientation of the roller cover is not limited to just the substantially horizontal and substantially vertical, and may be at any angle to the horizontal or vertical.

Preferably, the winding system is an even speed gear system.

Preferably, the supporting sheet is attached at one edge to the second spindle and at the opposing edge to the first spindle.

Preferably, the supporting sheet is adapted to support the cover portion of the roller cover on the first spindle.

Preferably, in a first, open position, the cover portion is releasably wound around the first spindle of the winding system. Preferably, in the first, open position, the supporting sheet is releasably wound between the layers of the cover portion around the first spindle.

Preferably, in a second, closed position, the cover portion is unwound from the first spindle. Preferably, in the second, closed position, the supporting sheet is releasably wound around the second spindle.

Preferably, the second spindle is adapted to be rotated about its longitudinal axis. Preferably, the rotation of the second spindle causes the supporting sheet to be wound around the second spindle. This rotation of the second spindle, and movement of the supporting sheet, causes the cover portion to be unwound from the first spindle.

Preferably, the winding system comprises a motor to drive the rotation of the second spindle. Preferably, the motor is adapted to rotate the second spindle at a constant speed.

Alternatively, the winding system comprises a crank arm to allow manual rotation of the second spindle.

Preferably, the supporting sheet comprises a thin sheet of material, preferably a strong, plastics material. This allows the constant speed rotation of the second spindle to unwind the cover portion from the first spindle at a relatively constant speed.

Preferably, the supporting sheet is textured to provide a greater coefficient of friction. Preferably, the supporting sheet is ribbed.

Alternatively, the supporting sheet may comprise a material having a high coefficient of friction, for example a rubber material.

The supporting sheet may extend the entire width of the roller cover parallel to a longitudinal axis of the spindle, or may be a thin strip of material. The winding system may comprise two or more supporting sheets adapted to be received about the second spindle.

The second spindle may be located such that, when the roller cover is fully wound around the first spindle, the supporting sheet is located on either the inside of the last turn of the roller cover body, or the outside of the last turn of the roller cover body.

Preferably, the winding system is a winding system for a roller cover. More preferably, the winding system is a winding system for a roller cover of a hot tub, swim spa or the like. Alternatively, the winding system may be a winding system for a door; compartment, such as a fridge or freezer; dividing wall; conveyor belt; and/or the like.

According to a third aspect of the invention, there is provided a winder suitable to wind a cover about a spindle, the winder comprising an arm secured substantially perpendicularly to the longitudinal axis of the spindle.

Preferably, the arm is fixedly secured to the spindle, preferably to a distal end of the spindle. Preferably, the arm extends beyond the diameter of the spindle. More preferably, the arm extends at least to the diameter of the spindle and roller cover when the cover is wound around the spindle.

Preferably, the arm is adapted to rotate with the spindle.

Preferably, the winder is adapted to catch a guide member extending from the cover when the cover is wound around the spindle. Preferably, the arm of the winder is operable to push the guide member such that it causes the cover to wind around the spindle. Preferably, the winder is operable to pull the guide member towards the spindle. In this way, the cover is wound neatly and tightly around the spindle.

Preferably, the winder is adapted to catch a plurality of guide members extending from the cover.

Preferably, the spindle, and thus the winder, is rotated by means of a motor. Alternatively, the spindle, and thus the winder, may be rotated manually.

Preferably, the winder is a winder for a spindle in a roller cover, preferably a roller cover for a hot tub, swim spa, or the like.

According to a fourth aspect of the invention, there is provided a drive system for raising and lowering a track, the drive system comprising an articulated arm rotatably attached at one end thereof to the track.

Preferably, the articulated arm is rotatably secured to a support member at its other end. Preferably, the articulated arm is rotatably attached at its articulation to a spindle.

Preferably, the articulation is attached to the spindle via a tape. Preferably, the tape is operable to be wound and unwound about the spindle, preferably by rotation of the spindle.

Preferably, the spindle is rotated by means of a motor. Alternatively, the spindle may be rotated manually.

Preferably, the articulation of the articulated arm is movable by means of rotation of the tape about the spindle. Preferably, the track is movable by means of the movement of the articulated arm.

Preferably, the track may comprise a plurality of legs to provide additional support. Preferably, the legs are operable to move with the track.

Preferably, the drive system is a drive system for a track for a roller cover, more preferably for a roller cover for a hot tub, swim spa, or the like.

According to a fifth aspect of the invention, there is provided a method of covering a hot tub, swim spa or the like with a roller cover, the method comprising the steps of:
a) raising a track above an upper surface of the hot tub, swim spa, or the like;
b) moving a roller cover along the track;
c) lowering the track to the height of the upper surface of the hot tub, swim spa or the like such that the roller cover forms a seal around the upper surface of the hot tub, swim spa, or the like.

Preferably, the roller cover is a roller cover according to the first aspect of the invention.

Preferably, the raising and lowering of the track is achieved using the drive system of the fourth aspect of the invention.

Preferably, the movement of the roller cover along the track is achieved using the winding system of the second aspect of the invention.

Preferably, the method may be reversed to uncover the hot tub, swim spa, or the like. Preferably, the reverse method includes the step of winding the roller cover about a spindle. Preferably, the step of winding the roller cover about the spindle is achieved using the winding system of the second aspect of the invention. Preferably, the step of winding the roller cover about the spindle is achieved using the winder of the third aspect of the invention.

Any of the features described above may be taken in any combination and with any aspect of the invention.

A preferred embodiment of the present invention will now be described, by way of example only, with reference to the following drawings, in which:

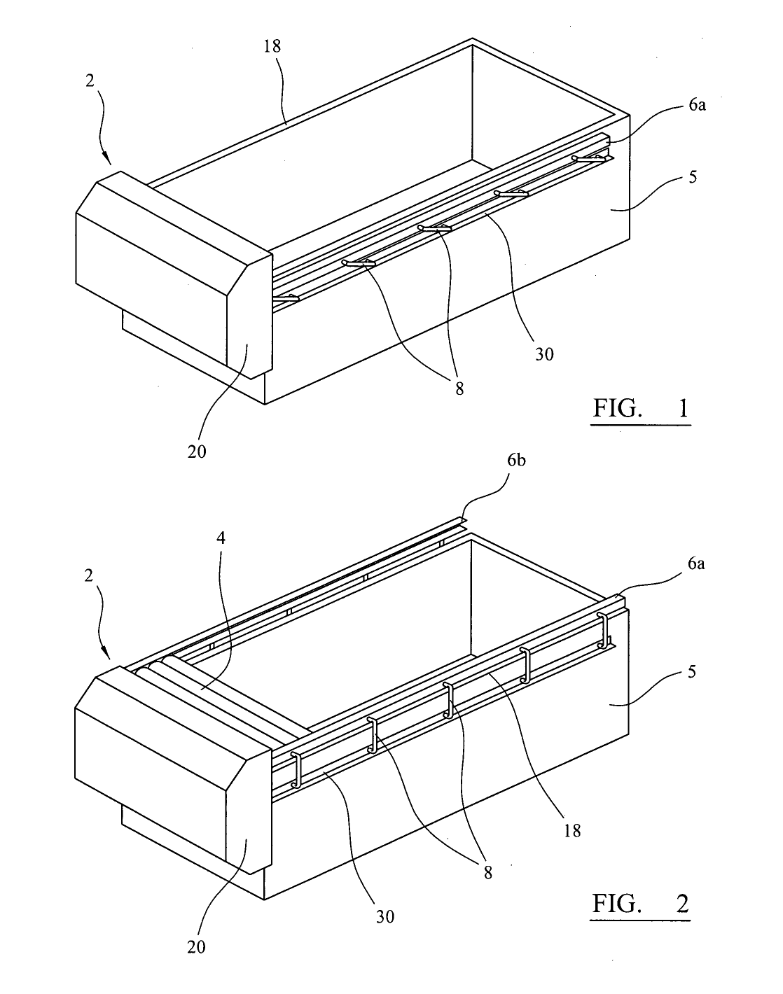

FIG. 1 shows a schematic, perspective view of a first embodiment of a cover in a fully open position;

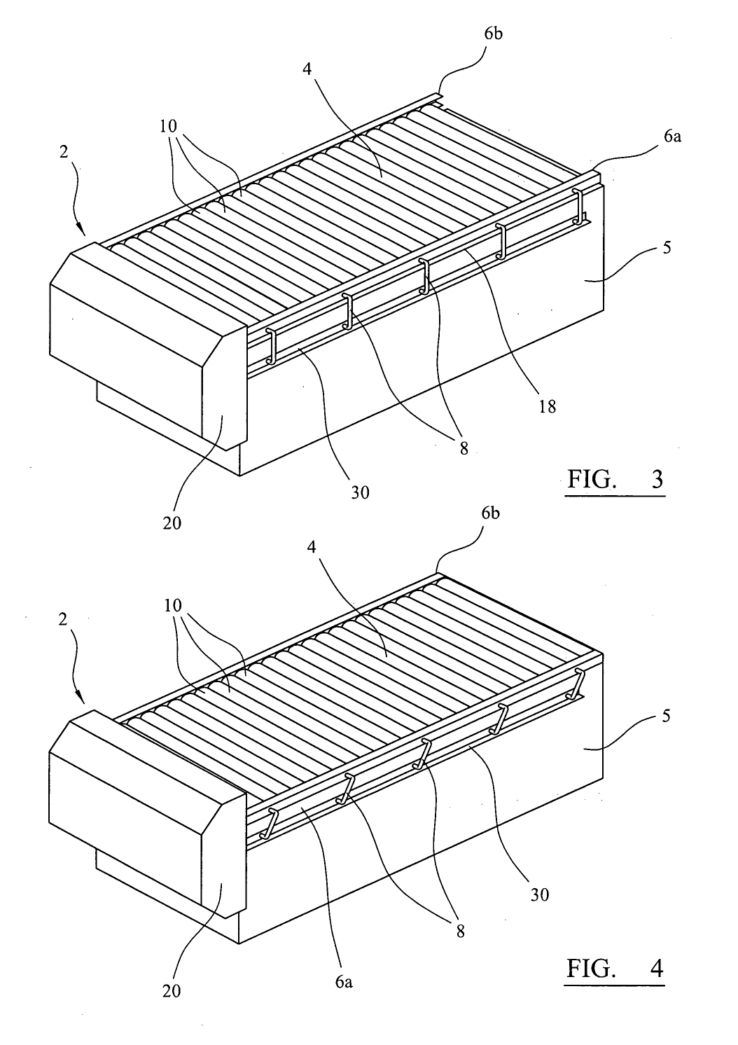

FIG. 2 shows a schematic, perspective view of the cover of FIG. 1 also in a partially open position;

FIG. 3 shows a schematic, perspective view of the cover of FIG. 1 in another partially open position;

FIG. 4 shows a schematic, perspective view of the cover of FIG. 1 in a closed position;

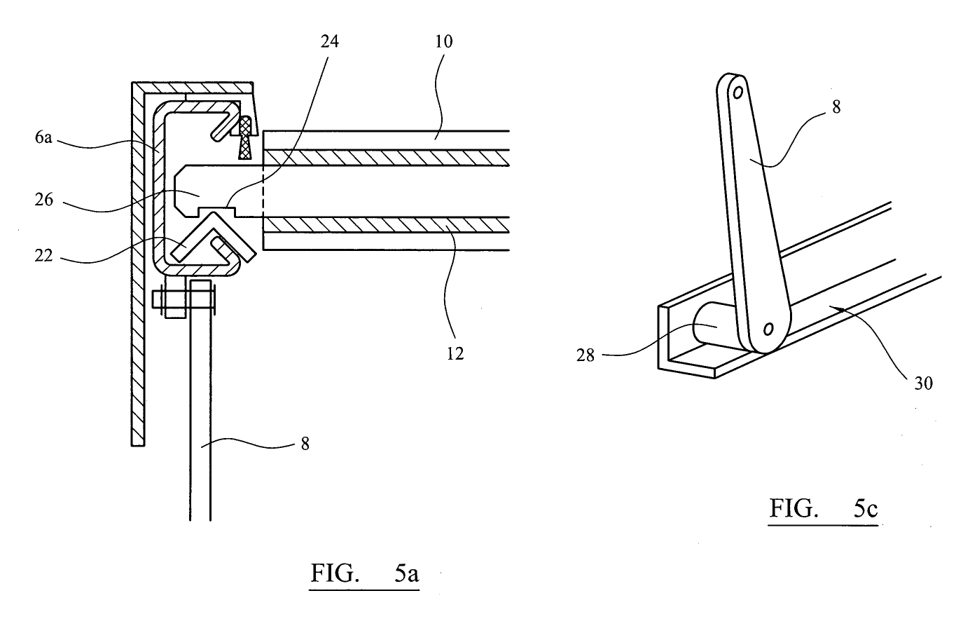

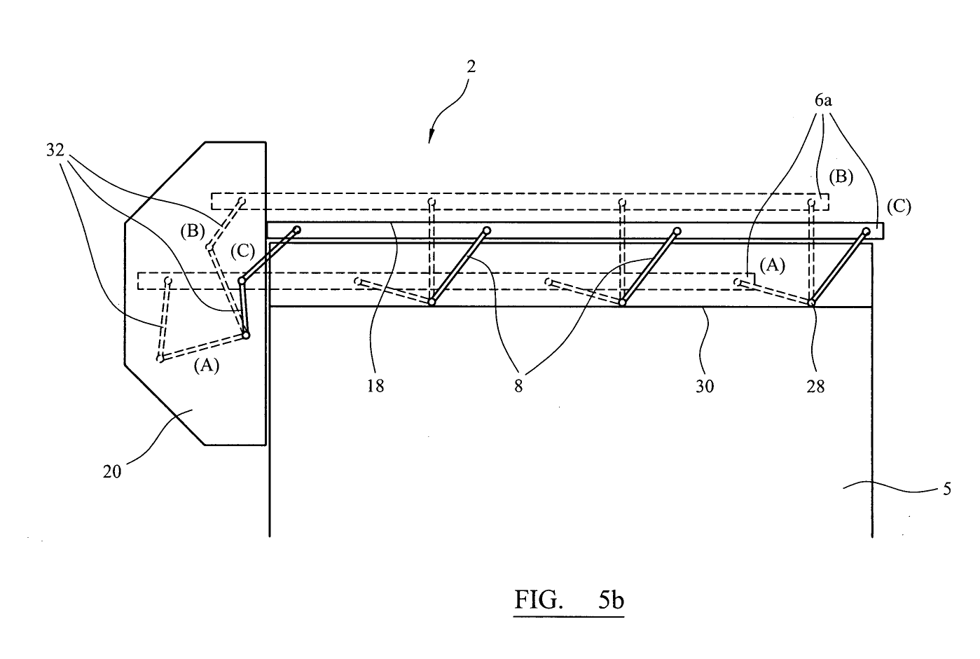

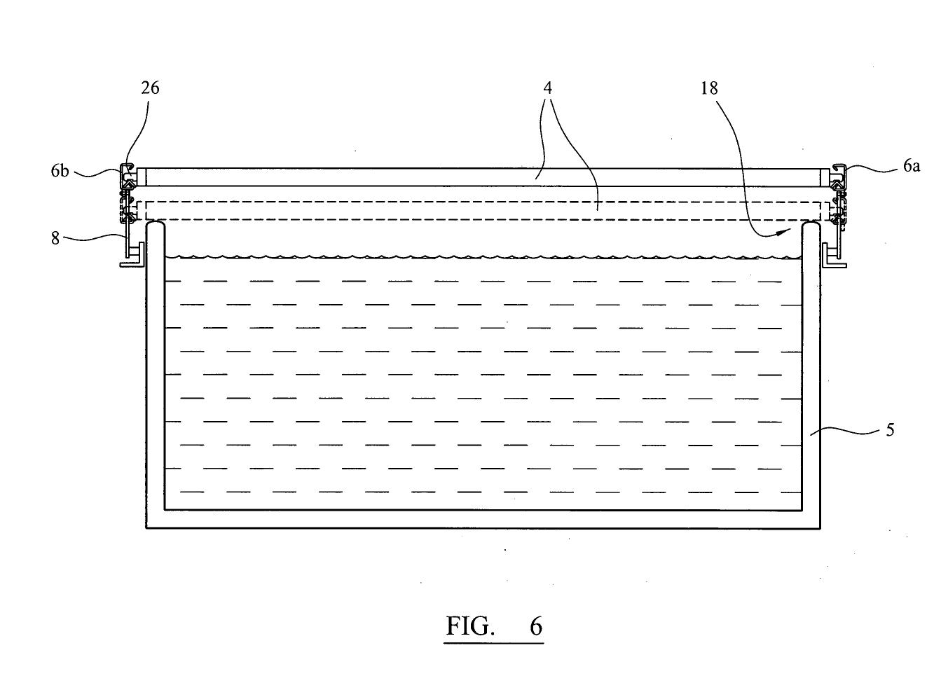

FIG. 5a shows a schematic, cross-sectional view of a track according to the invention;

FIG. 5b shows a schematic, side view of a track according to the invention in various positions between a stored position (1), a raised position (2) and a lowered position (3);

FIG. 5c shows a schematic, perspective view of a rotatable leg according to the invention;

FIG. 6 shows a schematic, cross-sectional view of the cover of FIG. 1;

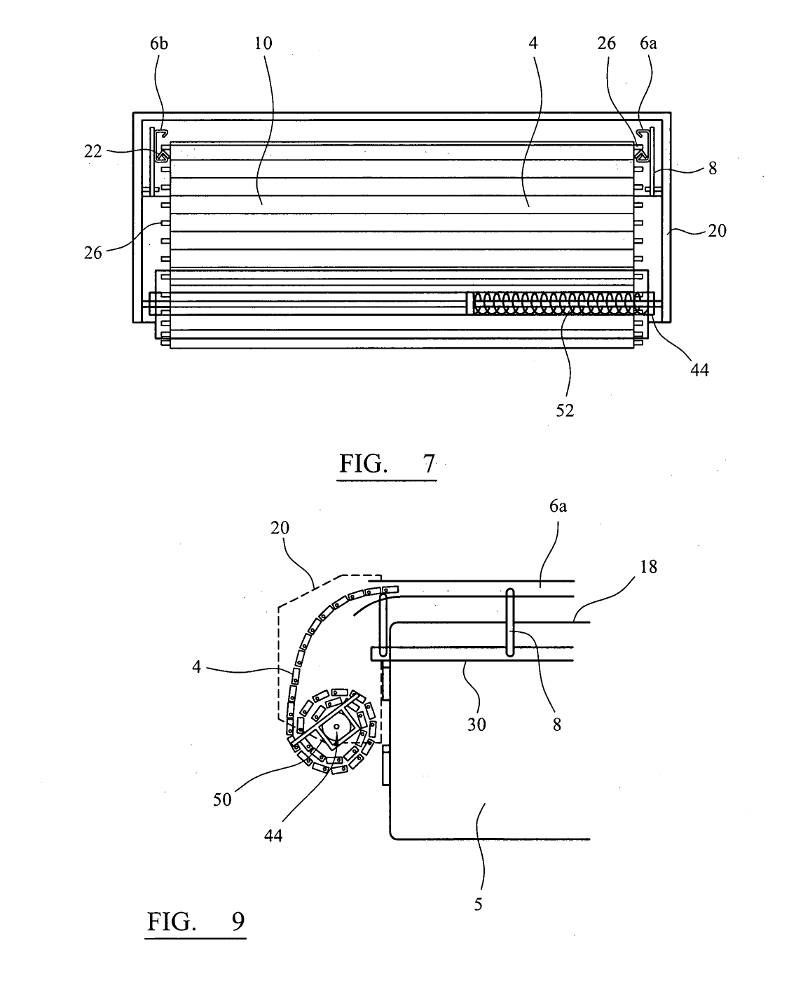

FIG. 7 shows a rear view of a storage position of the cover of FIG. 1;

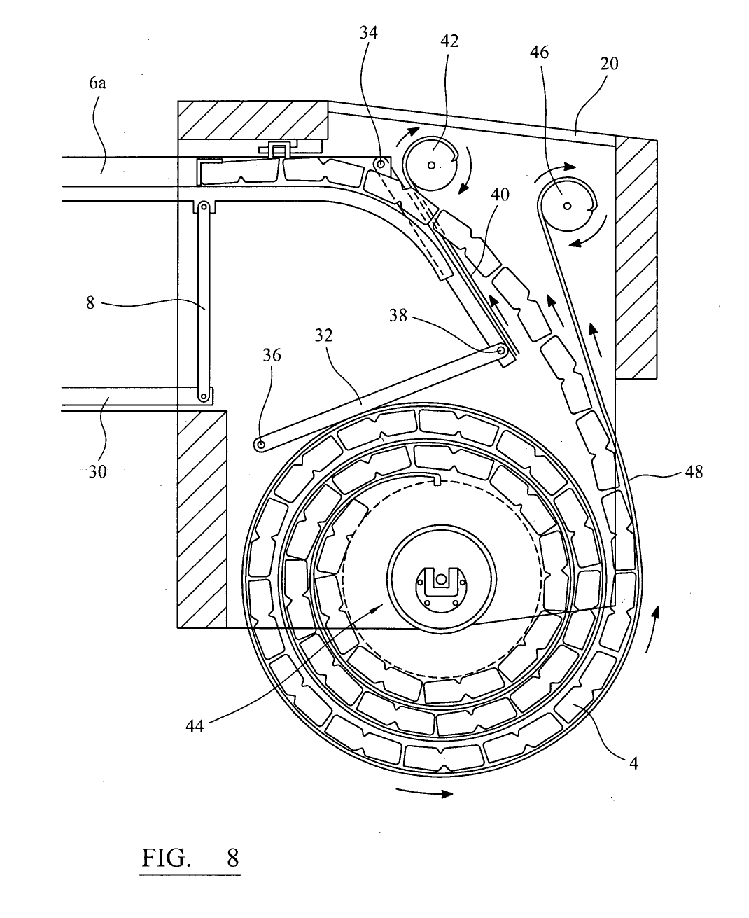

FIG. 8 shows a schematic, cross-sectional view of a first embodiment of a winding system according to the invention;

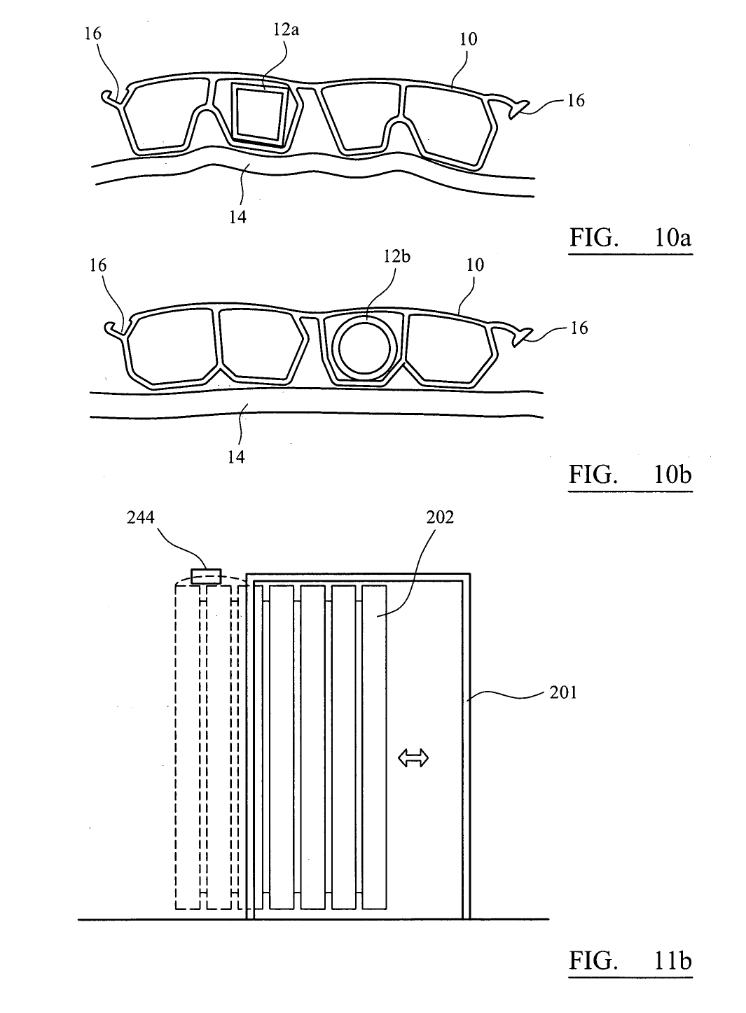

FIG. 9 shows a schematic view of a winder for the roller cover of FIG. 8;

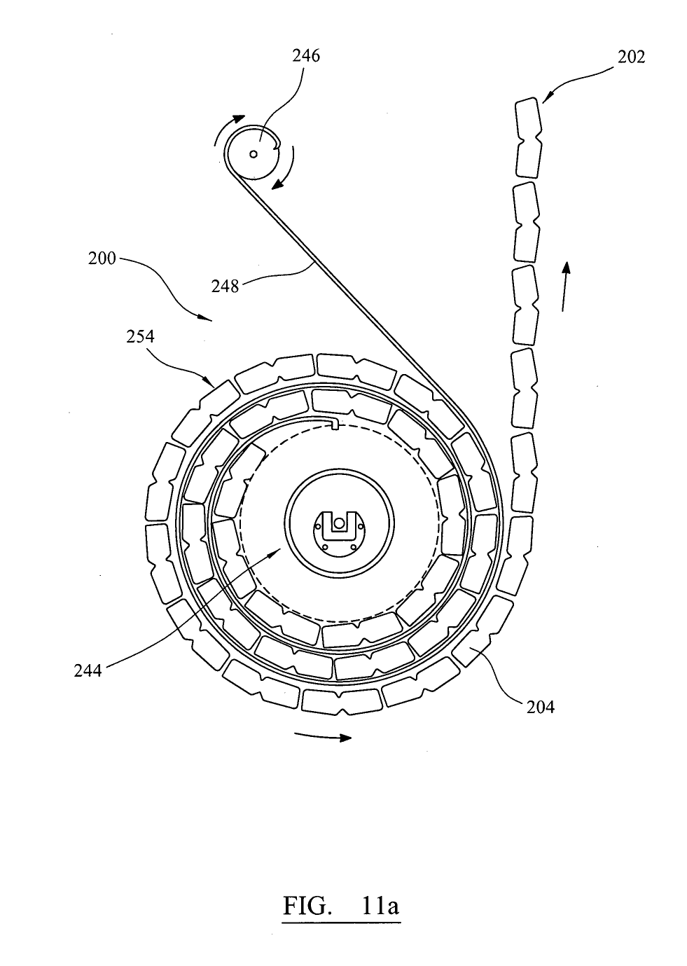

FIGS. 10 a and b show a schematic, cross-sectional view of a louvre of the roller cover of FIG. 1; and

FIG. 11 shows a schematic, cross-sectional view of a winding system according to a second embodiment of the invention.

Referring to FIGS. 1 to 4, a roller cover 2 for a hot tub, swim spa, or the like, comprises a body portion 4, two tracks 6a,b and a plurality of rotatable legs 8. The body portion 4 of the roller cover 2 is operable to move along the tracks 6a,b by means a motorised or manual mechanical drive.

The body portion 4 has substantially the same or a slightly larger width and length as the upper surface of the hot tub, swim spa, or the like, that it is adapted to cover. In this example, the cover 2 is shown on a swim spa 5. However, it would be obvious to a skilled person to make the appropriate changes to the width and length of the cover to customise it for other hot tubs and the like.

The body portion 4 of the roller cover 2 comprises a series of louvres 10. Each of the louvres 10 are made from a waterproof material, such as plastics materials, and are in watertight communication with the louvres 10 on either side thereof. As shown in FIGS. 10 a and b, the louvres 10 are hollow. The hollow cavities are adapted to receive a reinforcing strut 12. Depending on the shape of the louvres 10, the reinforcing strut 12 may be a steel tube with a square cross section 12a or a circular cross section 12b.

As also shown in FIG. 10, the louvres 10 are attached to a layer of waterproof, insulating material 14. This material 14 may be a foam material, such as an elastomer foam, or a gel material, such as Astrogel, or a combination thereof. The layer of waterproof, insulating material 14 helps to keep the louvres 10 in close connection and prevents any gaps in the insulation Of the roller cover 2 which may otherwise occur at the connections 16 between adjacent louvres 10.

A rubber seal (not shown) may be provided between the upper edge 18 of the swim spa 5 and the body portion 4 of the roller cover 2 to provide a better closure. The rubber seal may be attached to the body portion 4.

The body portion 4 of the roller cover 2 is stored in a housing 20 when in an open position.

The tracks 6a,b are mounted on opposing sides of the swim spa 5 below the upper edge 18 thereof. The tracks 6a,b extend substantially along the entire length of the sides of the swim spa 5 and are substantially perpendicular to the louvres 10 of the body portion 4. The tracks 6a,b may be integrally formed with the swim spa 5, or may be retrofitted to an existing swim spa 5. The tracks 6a,b are substantially C-shaped metal strips comprising an inverted ‘V’-shaped monorail 22, as shown in FIG. 5a. The monorail 22 is adapted to receive engagement portions 24 of guide members 26 located within, and extending from, the body portion 4.

As shown in FIG. 5a, the guide members 26 comprise nylon, or a similar low friction material, rods. The guide members 26 are mounted in the body portion 4 of the cover 2, at the ends of the louvres 10. More specifically, the guide members 26 are mounted within the steel reinforcing struts 12. The guide members 26 each have engagement portions 24 which are designed to engage and slide along the tracks 6a,b as the cover 2 is moved from an open position to a closed position and back again.

As can be seen in FIGS. 5b and c, the rotatable legs 8 are rotatably attached at one end to mounts 28 on a support rail 30 and at their other end to one of the tracks 6a,b. The support rail 30 is fixedly mounted on the side of the swim spa 5.

The rotatable legs 8 are adapted to rotate about their mounts 28 on the support rail 30 from a first, substantially horizontal position (A), through a second position (B) where they are substantially perpendicular to the tracks 6a,b, to a third position (C) where they are at a substantially acute angle to the tracks 6a,b.

The rotation of the rotatable legs 8, and thus the movement of each track 6a,b is driven by an articulated arm 32. The articulated arm 32 is rotatably attached at one end 34 thereof to the track 6a. The articulated arm 32 is rotatably secured to a support member 36 at its other end. The articulated arm 32 is rotatably attached at its articulation 38 via a tape 40 to a spindle 42.

The spindle 42 is operable to be rotated by means of a motor (not shown). The rotation of the spindle 42 winds and unwinds the tape 40 about the spindle 42 and causes the articulated arm 32 to rotate about its support member 36 and move the track 6a. This rotation of the arm 32 raises and lowers the track 6a, and thus the rotatable legs 8. The rotatable legs 8 provide extra support to the track 6a,b during the raising and lowering movements.

Referring now to FIG. 6 the body portion 4 exhibits a slight camber in the closed position (dotted lines). The camber is effected by the downward pressure of the tracks 6a,b on the body portion 4 of the roller cover 2, which bends the body portion 4 slightly over the upper edge 18 of the swim spa 5. The camber helps to prevent rain water, leaves or other detritus from collecting on the body portion 4 of the roller cover 2.

Referring now to FIG. 8, the roller cover 2 comprises a spindle 44 located in the housing 20, about which the body portion 4 is stored when the cover 2 is in an open position. The louvres 10 of the body portion 4 allow the body portion 4 to be wound around the spindle 44. The body portion 4 of the roller cover 2 is wound and unwound about the spindle 44 by rotation of the spindle 44.

The rotation of spindle 44 is effected by rotation of a second spindle 46, over which a strong strap material 48 is wound. The strap material 48 is attached at one end to spindle 46 and at its other end to spindle 44. The rotation of spindle 46 winds and unwinds the strap material 48 about the spindle 46, and thus the strap material 48 is unwound and wound about the spindle 44 respectively. A motor (not shown) is provided to drive the rotation of spindle 46. A spring 52 is also provided to aid in the rotation of spindle 44. The spring 52 is wrapped around the spindle 44 as shown in FIG. 7, and tightens as the body portion 4 unwinds, thus aiding the rewinding of the body portion 4 as the spring 52 returns to its original shape.

The strap material 48 acts as a support to the body portion 4 of the roller cover 2 when being wound and unwound about spindle 44. The strap material 48, when wound about spindle 44 is wound between the layers of the body portion 4 which are wound about spindle 44.

Referring now to FIG. 9, the spindle 44 further comprises an arm 50 secured perpendicularly to the longitudinal axis of the spindle 44 at one end of the spindle 44. The arm 50 extends beyond the diameter of the spindle 44 and body portion 4 when the body portion 4 is wound about spindle 44.

The arm 50 acts as a winder to neatly and tightly wind the body portion 4 about the spindle 44. The arm 50 is adapted to engage the guide members 26 on the body portion 4 as they pass next to the spindle 44, and to pull them round as the spindle 44 rotates to wind the body portion 4 around the spindle 44.

In use, the roller cover 2 is closed by activating a motor (not shown) to drive the rotation of spindle 42. The rotation of the spindle 42 causes the tape 40 to wind around the spindle 42 and move the articulated arm 32. The articulation 38 of the arm 32 moves towards the spindle 42 and pushes the track 6a,b and rotatable legs 8 from their first position (A) into their second position (B) wherein the track 6a,b is raised above the upper surface 18 of the swim spa 5. The position of the track 6a,b provides a clearance of approximately 40 mm between the upper surface 18 of the swim spa 5 and the track 6a,b. This prevents the body portion 4 coming into contact with the edge 18 of the swim spa 5.

The spindle 46 is then rotated and the strap material 48 is wound around the spindle 46. The winding of the strap material 48 about the spindle 46 causes the body portion 4 to unwind from the spindle 44 with the strap material 48. As the body portion 4 is unwound from the spindle 44, the louvres 10 push each other along the tracks 6a,b such that the guide members 26 engage with and slide along the monorails 22.

Once the body portion 4 has been unwound from the spindle 44 and fully extended from the housing 20, the articulated arm 32 is moved into its third position such that the track 6a,b and rotatable legs 8 are moved from their second substantially perpendicular position (B) into their third, acute angle position (C) to bring the body portion 4 into contact with, and form a seal around, the upper edge 18 of the swim spa 5. This action is effected by further rotation of spindle 42 to wind more of the tape 40 around the spindle 42.

To move the roller cover 2 from its closed position to its open position, the tracks 6a,b are raised off the upper surface 18 of the swim spa 5 by rotation of the spindle 42 to unwind the tape 40 and raise the articulated arm 32. The raising of the tracks 6a,b raises the rotatable legs 8 from their third position (C) such that they are substantially perpendicular (B) to the tracks 6a,b. The body portion 4 is thereby lifted off the upper surface 18 of the swim spa 5.

The spindle 46 is then rotated to unwind the strap material 48. As the strap material 48 is unwound, the body portion 4 is pulled back along the tracks 6a,b towards the housing 20 and is wound around the spindle 44 between the layers of the strap material 48. The arm 50 catches the guide members 26 as they pass next to the spindle 44 and pull them around the spindle 44 as the spindle 44 rotates. This keeps the body portion 4 wound neatly and tightly around the spindle 44.

Once the body portion 4 is fully wound around the spindle 44, the spindle 42 is rotated to unwind the tape 40 and lower the articulated arm 32. The lowering of the articulated arm 32 lowers the tracks 6a,b and the rotatable legs 8 to their first substantially horizontal position (A).

No scratching of the upper edge 18 of the swim spa 5 occurs in the movement of the roller cover 2 because the body portion 4 is not in contact with the swim spa 5 during the movement.

Referring now to FIGS. 11a and b, a second embodiment of a winding system 200 according to the present invention is shown. The winding system according to the second embodiment of the invention operates the winding and unwinding of a door. The winding system therefore operates a substantially vertically orientated roller cover to cover the doorway 201. The roller cover 202 of the second aspect of the invention comprises a spindle 244 located in the housing 220, about which the body portion 204 is stored when the cover 202 is in an open position. The body portion 204 of the roller cover 202 is wound and unwound about the spindle 244 by rotation of the spindle 244.

The rotation of spindle 244 is effected by rotation of a second spindle 246, over which a strong supporting material 248 is wound. The supporting material 248 is attached at one end to spindle 246 and at its other end to spindle 244. The rotation of spindle 246 winds and unwinds the supporting material 248 about the spindle 246, and thus the supporting material 248 is unwound and wound about the spindle 244 respectively. A motor (not shown) is provided to drive the rotation of spindle 246.

The supporting material 248 acts as a support to the body portion 204 of the roller cover 202 when being wound and unwound about spindle 244. The supporting material 248, when wound about spindle 244 is wound between the layers of the body portion 204 which are wound about spindle 244. The spindle 246 is positioned such that the supporting material 248 is located on the inside of the last turn 254 of the body portion 204 of the roller cover 202 when in the fully open position. This ensures that the roller cover moves unhindered in a substantially linear plane to cover the doorway. This is unlike the situation in the first embodiment of the invention where the spindle 46 is positioned such that the strap material 48 is located on the outside of the last turn 54 of the body portion 4 of the roller cover 2 when in the fully open position. In the first embodiment, the spindle 46 is positioned such that the roller cover 2 may move unhindered in a substantially curved manner prior to engaging with the tracks 6a,b.

The winding system described above may be used with the winder, driving system and/or roller cover described with reference to the first embodiment of the invention, or may be used with similar winders, driving systems and/or roller covers to serve alternative purposes. It will be appreciated by the skilled person that the alternative winders, driving systems and/or roller covers could be manufactured and operated in an analogous way to those described with reference to the first embodiment of the invention in any other application, for example in the use of the winding system of the second embodiment of the invention to operate a roller door, or any other purpose.

It will be appreciated by the skilled person that the winding system 200 of the present invention can be used for other applications in addition to those described above with reference to FIGS. 8 and 11. In these other applications, the winding system is constructed in the same way and is operated in the same manner as those systems described above.

The roller cover of the present invention provides an easy way to uncover and recover a hot tub, swim spa, or the like. The action of the cover moving along a track mounted on a tub, spa, etc. means no lifting has to be done to move the cover. Furthermore, the mechanisation of the cover allows a user to press a button to open to cover, which can then be opening as the user is getting changed, and press a button again to close the cover, such that the user can go inside and/or dry off whilst the cover is closing.

The roller cover also provide a neat solution to the storage of hot tub, swim spa, etc covers. Instead of having a large piece of vinyl covered polystyrene propped up against the side of a tub, spa, etc, against another supportive surface, on the floor, etc, whilst the tub, spa etc is in use, the device of the present invention stores the cover in a housing rolled around a spindle. Thus the cover is stored in a more visually appealing way, or may be out of sight completely, and takes up less space than the traditional covers.

The extension and retraction of the track, from and to its storage location out of the way of, and below the upper surface of the swim spa or hot tub's access edge, provides a solution to having to fix a permanent channel for a roller shutter which would be both sharp and unsightly to users during bathing or swimming.

The winding system provides an even-speed gear that can be used to open and close any type of cover. The skilled person will appreciate the myriad of uses available for the winding system. Some of the possible uses include the hot tub cover and door mechanism described above, as well as conveyor belt type systems, loading mechanisms, for example for loading luggage and/or cargo onto vehicles such as aircraft, road vehicles and/or ships, and other applications.

The winding system of the present invention provides a system which allows a movement of a cover to be made in any linear, or indeed non-linear plane. The supporting sheet means that the weight of the cover is not required to facilitate its motion as is required in conventional roller cover/shutter systems. Therefore, the winding system can be used in non-vertical motion situations, as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1) A roller cover comprising a body portion, a track and a body portion retaining means, wherein the said track is external to the body portion retaining means and the body portion is moveable along the track.

2) The roller cover of claim 1, wherein the body portion is moveable along the track in a substantially horizontal plane.

3) The roller cover of claim 1, wherein the body portion retaining means is a housing.

4) The roller cover of claim 1, wherein the body portion is stored around a spindle when the cover is open.

5) The roller cover of claim 4, wherein the spindle is located within the body portion retaining means.

6) The roller cover of claim 1, wherein the track comprises a guide along which the body portion is movable.

7) The roller cover of claim 1, wherein the body portion comprises at least one guide member.

8) The roller cover of claim 7, wherein the or each guide member fits over the guide in the track, and is movable therealong.

9) A winding system for a roller cover, the winding system comprising a first spindle adapted to receive a cover portion of the roller cover, and a second spindle adapted to receive a supporting sheet.

10) The winding system according to claim 9, wherein the winding system is operable to wind and unwind a roller cover about the first spindle.

11) The winding system according to claim 9, wherein the supporting sheet is attached at one edge to the second spindle and at the opposing edge to the first spindle.

12) The winding system according to claim 9, wherein the supporting sheet is adapted to support the cover portion of the roller cover on the first spindle.

13) The winding system according to any of claim 9, wherein the second spindle is adapted to be rotated about its longitudinal axis.

14) A winder suitable to wind a cover about a spindle, the winder comprising an arm secured substantially perpendicularly to the longitudinal axis of the spindle.

15) The winder according to claim 14, wherein the arm is adapted to rotate with the spindle.

16) The winder according to claim 14, wherein the winder is adapted to catch a guide member extending from the cover when the cover is wound around the spindle.

17) The winder according to claim 16, wherein the arm of the winder is operable to push the guide member such that it causes the cover to wind around the spindle.

18) The winder according to claim 16, wherein the winder is operable to pull the guide member towards the spindle.

19) A drive system for raising and lowering a track, the drive system comprising an articulated arm rotatably attached at one end thereof to the track.

20) The drive system of claim 19, wherein the articulated arm is rotatably secured to a support member at its other end.

21) The drive system of claim 19, wherein the articulated arm is rotatably attached at its articulation to a spindle.

22) The drive system of claim 19, wherein the articulation of the articulated arm is attached to the spindle via a tape.

23) The drive system of claim 22, wherein the tape is operable to be wound and unwound about the spindle by rotation of the spindle.

24) The drive system of claim 22, wherein the articulation of the articulated arm is movable by means of winding of the tape about the spindle.

25) The drive system of claim 19, wherein the track is movable by means of the movement of the articulated arm.

26) A method of covering a hot tub, swim spa or the like with a roller cover, the method comprising the steps of:
a) raising a track above an upper surface of the hot tub, swim spa, or the like;
b) moving a roller cover along the track;
c) lowering the track to the height of the upper surface of the hot tub, swim spa or the like such that the roller cover forms a seal around the upper surface of the hot tub, swim spa, or the like.

27) The method of claim 26, wherein the roller cover is a roller cover according to the first aspect of the invention.

28) The method of claim 26, wherein the raising and lowering of the track is achieved using the drive system of the fourth aspect of the invention.

29) The method of claim 26, wherein the movement of the roller cover along the track is achieved using the winding system of the second aspect of the invention.

30) The method of claim 26, wherein the method may be reversed to uncover the hot tub, swim spa, or the like.
